(19) United States
(12) Patent Application Publication
(10) Pub. No.: US 2014/0162226 A1
(43) Pub. Date: Jun. 12, 2014

(54) Potty Training Educational System

(71) Applicant: Linfred Longenecker, South Bend, IN (US)

(72) Inventor: Linfred Longenecker, South Bend, IN (US)

(21) Appl. No.: 14/099,223

(22) Filed: Dec. 6, 2013

Related U.S. Application Data
(60) Provisional application No. 61/735,219, filed on Dec. 10, 2012.

(51) Int. Cl. G09B 19/00

(52) U.S. Cl. CPC G09B 19/0076
USPC 434/236

(57) ABSTRACT

Systems and methods for use of a potty training system. The potty training system includes a compressible doll and a model toilet. The doll is shaped like an animal, a fictional creature or a human. The doll has an internal storage compartment for holding fluids and an aperture creating a pathway between the exterior environment and the internal storage compartment. Fluids may be pulled into the internal storage compartment, expelled by compressing the doll, and released into the model toilet. The model toilet may have several components of a functioning toilet. Additionally the model toilet may have a drain for releasing the fluids collected and suction cups for attaching the model toilet to a surface. Used in this manner, the potty training system may be used by a young child in the bathtub to create a positive association between urination and a toilet.

### CROSS-REFERENCE TO RELATED APPLICATIONS

This application claims priority from U.S. Provisional Application No. 61/735,219, the disclosure of which is hereby incorporated in its entirety by reference.

### TECHNICAL FIELD

This method and system relates to the mechanical arts and more specifically to an educational system for children.

### BACKGROUND

Potty training is a big step for children and parents alike and the process can be an intimidating part of parenting. Stress and frustration associated with potty training include determining a child's readiness, both biologically and emotionally. Couple this with the social pressures on parents, chiefly to potty train children early, and it is understandable that many parents dread the prospect of potty training

Some children are unwilling to use a toilet, either out of fear or because they fail to recognize any purpose or benefit to doing so. Parents employ methods to provide incentives for children to use the toilet for potty. Many also seek potty training aids from a variety of forms such as, potty chairs and related devices, books and DVDs, and toys. While the existence of such aids has somewhat helped ease the general challenges for parents in the potty training process, there remains a need for tools to facilitate early potty training

### BRIEF SUMMARY

The following presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

The present device is a potty training system for children to use throughout the potty training process and may be used to teach a child to associate a toilet with urination. In embodiments, the potty training system includes both an animal-shaped doll and a model toilet. The animal-shaped doll can be capable of simulating urination into the model toilet. It is understood that a child may use the potty training system to associate the act of urination with a functioning toilet. In embodiments, the potty training system may be used by a child in the bathtub, or with any pool of liquid.

In one embodiment, the doll has a compressible body and anatomical features of an animal. In other embodiments, the doll can take the shape of mythical creatures, cartoons, humans, or any other suitable shape. The doll can have an internal compartment for holding a fluid as well as an aperture that connects an internal compartment and the exterior environment. In embodiments, the same aperture can be used for both intake and release of the fluid from inside the interior compartment, however, it is understood that the body may have multiple apertures. In embodiments, when the animal-shaped body is compressed, the internal compartment is also compressed and the fluid is released, exiting through the aperture. It is understood that the aperture may be capable of creating a squirt effect or a squeak effect upon release of the fluid depending on the nature of the fluid (liquid or gas) and the design of the aperture.

In embodiments, the doll is used in conjunction with the model toilet. The model toilet may be comprised of many of the components of a functioning toilet such as a toilet bowl, a toilet seat and a toilet lid. However, it is understood that the model toilet may have additional or fewer components. In embodiments, the model toilet includes at least one suction cup, which can be attached to the back of the toilet. It is understood that the suction cup or suction cups be used to temporarily affix the model toilet to a surface. Use of the suction cups may free the child's hands for gripping the doll. In embodiments, the model toilet further includes a drain that allows fluid to empty from the bowl. In one embodiment the model toilet may be made of a hard plastic. However, it is understood that the model toilet may be made from softer plastic or from other water resistant materials such as porcelain, wood or rubber. It is further contemplated that the model toilet be sized and configured to be proportional to the shaped doll, however it is understood that the model toilet may take any size or shape.

### BRIEF DESCRIPTION OF THE DRAWINGS

The systems, devices and methods may be better understood by referring to the following description in conjunction with the accompanying drawings, in which like numerals indicate like structural elements and features in various figures. The components in the figures are not necessarily to scale, and simply illustrate the principles of the systems, devices and methods. The accompanying drawings illustrate only possible embodiments of the systems, devices and methods and are therefore not to be considered limiting in scope.

FIG. 1 is a perspective view of an embodiment of a potty training system.

FIG. 2 is a side view of an embodiment of a doll of the potty training system.

FIG. 3 is a front view of an embodiment of the doll illustrating the compressible nature of the embodiment.

FIG. 4 is a cutaway view of an embodiment of a toilet of the potty training system.

FIG. 5 is a top view of an embodiment of the toilet.

FIG. 6 is a back view of an embodiment of the toilet.

### DETAILED DESCRIPTION

Aspects of the potty training system are described below with reference to illustrative embodiments. The references to illustrative embodiments below are not made to limit the scope of the described systems and methods but instead the illustrative embodiments are used to aid in the description of various aspects of the potty training system. The description, made by way of example and reference, is not meant to be limiting in regards to any aspect of the systems and methods. The description provides for developing and operating the device in connection with the device illustrated in the drawings. It is to be understood that the same or equivalent functions may be accomplished with different embodiments within the scope of this description. It is to be further understood that the use of relational terms are for descriptive purposes and do not require any actual relationship or order between such entities.

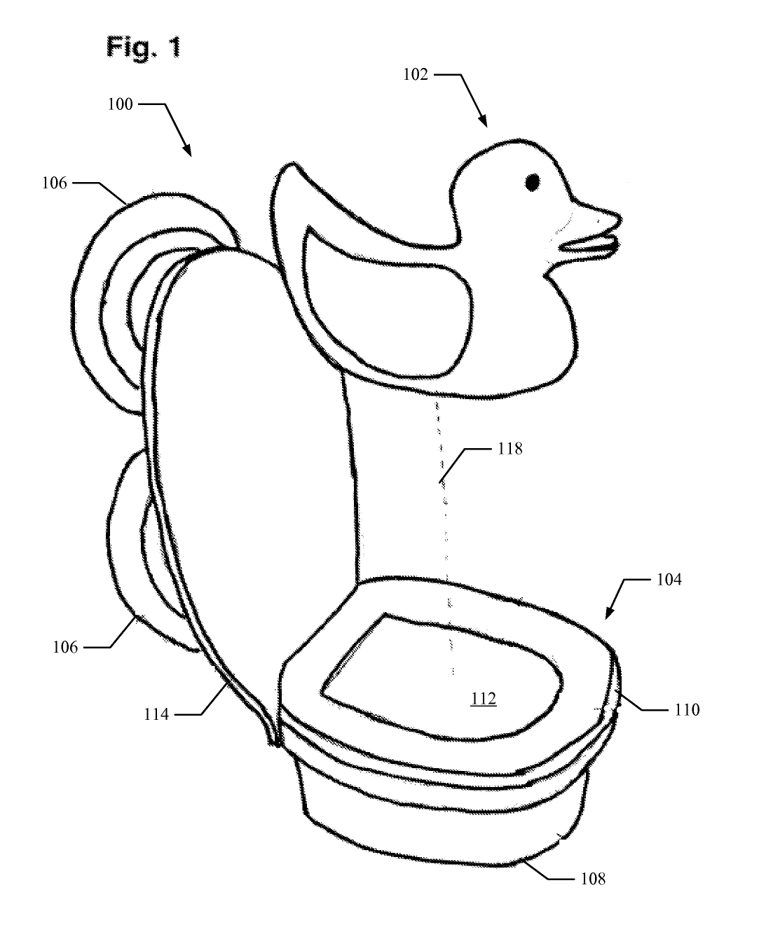

With reference to FIG. 1, an embodiment of a potty training system 100 is illustrated. In one embodiment, the potty training system 100 includes an animal-shaped doll 102 and a model toilet 104. The doll 102 can be used with the model toilet 104 to demonstrate proper toilet use and introduce potty training to a child in a positive way. The potty training system 100 may be used as a potty training tool, a toy for children, or both. It is an important goal of potty training that children associate the act of urination with a toilet and it is contemplated that using the potty training system 100 will help a child make that association.

In one embodiment, the animal-shaped doll 102 is capable of releasing liquid 118 into the model toilet 104. It is intended that the child position the animal-shaped doll 102 roughly centered over top of the model toilet. When the liquid is released from the animal-shaped doll 102, the liquid entering the model toilet 104 resembles urination into a functioning toilet. In embodiments, the doll 102 is sized and shaped so that it can be easily grasped by a small child, allowing the child to take an active role in the play and training The doll 102 and model toilet 104 used in this way may be a non-threatening and non-intimidating way to introduce children to potty training

In one embodiment the child may use the potty training system 100 in the bathtub. The doll 102 and model toilet 104 can be formed from materials conducive to bathtub play, such as rubber, plastic or other non-porous, quick-drying materials. In addition to the bathtub, the child may use the potty training system 100 with any liquid such as water from a sink, shower, or pool. The use of the potty training system 100 in the bathtub may make the toy easier to use as the water is contained within the bathtub and is not released into other areas of the house, making cleanup easier. Additionally, the bathtub is a fun environment for a child and thus using the potty training system 100 in the bathtub may create a positive association with the potty training system 100, alleviating some of the pressures of potty training

In embodiments, the doll 102 is elastic and compressible and may be shaped like an animal. In one embodiment, the doll 102 may be anatomically shaped like a duck, as shown; however, it is understood that the doll 102 may take the shape of any animal known or unknown. As used herein, the term “doll” encompasses a wide range of figures, including but not limited to, representations of humans, animals, anthropomorphized animals, cartoons, mythical creatures, and the like. For example, the doll 102 can be shaped like a mythical creature (e.g., a unicorn), cartoon animal (e.g., Winnie-the-Pooh or Mickey Mouse) or may even take the shape of a human being. The doll 102 may be any shape that would encourage the child to use the potty training system 100 as a toy. The doll 102 may also take a shape with which the child would identify or seek to emulate, such as a favorite character from a television show or book. The doll 102 may be sized proportionally to the model toilet 104, such that the child associates the two together. In embodiments, the doll 102 is sized and shaped to be grasped easily by a toddler, such that the child is able to manipulate and play with the potty training system 100. However, it is understood that the doll 102 may take any size and any shape.

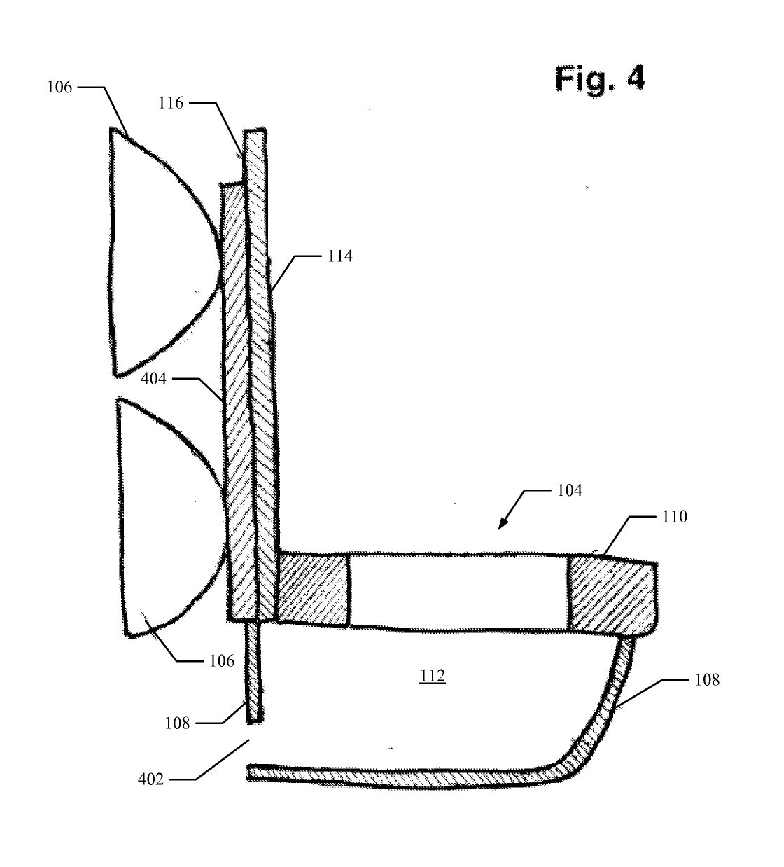

In embodiments, the model toilet 104 is shaped like a functioning toilet and may be comprised of scaled models of several of the elements of a functioning toilet. For example, as depicted, the model toilet can include a toilet seat 110 and a toilet bowl 108 with an interior 112. In an embodiment, the toilet model 104 can also include a lid 114 and backside 116, visible in FIG. 4, with one or more suction cups 106 attached to the backside 116. It is contemplated that the suction cups 106 allow the model toilet 104 to be attached to a surface such as a bathtub, so that the toilet model 104 is held in place while the child plays with the doll 102. The model toilet 104 may be proportionally sized to the doll 102. However, it is understood that the model toilet 104 may take any size and any shape.

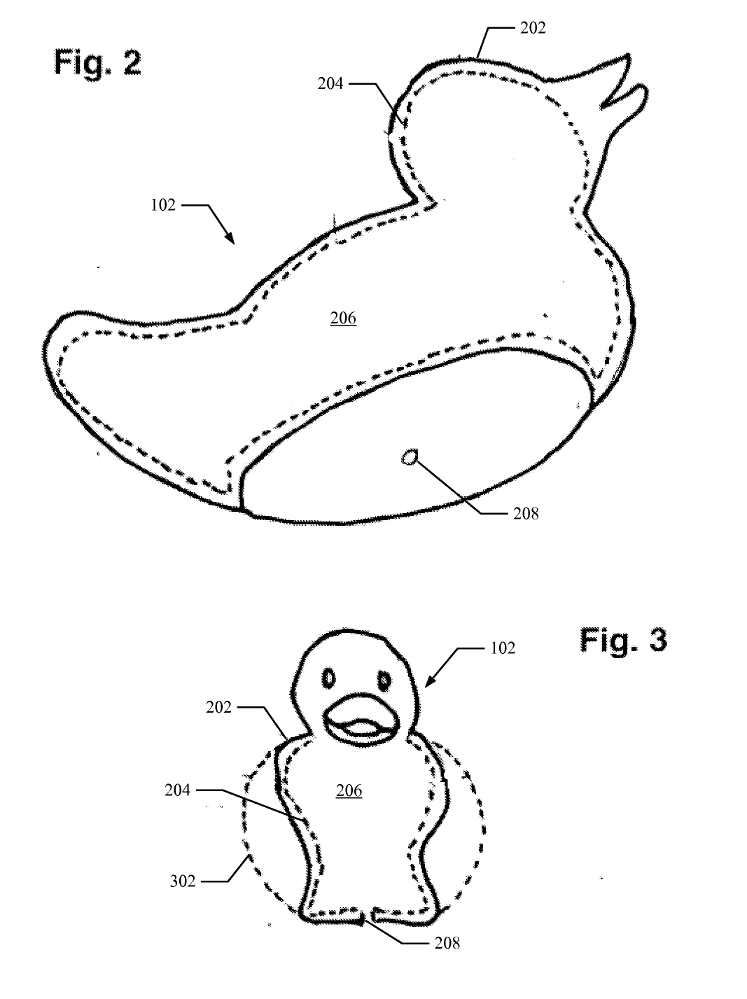

With reference to FIG. 2, an embodiment of the doll 102 is illustrated. In one embodiment, the structure of the doll 102 has an exterior surface 202 and an interior surface 204. The distance between the external surface 202 and internal surface 204 may vary. In embodiments, the thickness of the doll 102 between the external surface 202, and internal surface 204, and material from which the doll 102 is formed, are such that a small child would be capable of deforming the doll 102. This would allow the child to use the potty training system 100 on his or her own without the aid of an adult, allowing the child to be an active participant in potty training In another aspect of this embodiment, the doll has an internal compartment 206 that holds the fluid. As used herein, the term “fluid” means a liquid or a gas. When the doll 102 is compressed, the internal surface 204 will deform and the volume of the internal compartment 206 will correspondingly be decreased, forcing the fluid from the aperture 208.

In embodiments, the doll has an aperture 208 creating a pathway through the external surface 202 and the internal surface 204 as well as between the exterior of the doll 102 and the internal compartment 206 of the doll 102. In an embodiment, the aperture 208 is positioned near the bottom center of the doll 102. However, it is understood that the aperture 208 may be positioned anywhere on the doll 102. While a single aperture 208 is illustrated, there may also be more than one aperture 208 on the doll 102. In one embodiment the aperture 208 is circular. However, in other embodiments the aperture 208 may be any suitable shape. For example, the aperture can be a slit, such that when the doll 102 is compressed, the elastic nature of the doll opens the aperture 208, and when the doll 102 is released, the aperture 208 effectively closes, as the sides of the slit abut and hold the fluid in place. In embodiments, the aperture 208 may be sized or shaped such that when the interior compartment is filled with fluid, the fluid is held within the internal compartment 206, and either does not leak or leaks minimally by the force of gravity alone. The aperture 208 may also be sized or shaped and configured to make a squirt or a squeaking sound when air is released from the doll 102.

With reference to FIG. 3, an embodiment of the doll 102 is illustrated in the compressed position. It is contemplated that the duck be compressed when a child or parent pushes the exterior surface 202 inward towards the center of the doll 102. The doll 102 may be sized and configured such that it easily used by a child. Upon compression of the doll 102, the interior surface 204 will move in relation to the exterior surface 202. It is contemplated that the compression of the doll 102 will decrease the volume of the internal compartment 206. Consequently, the fluid within the internal compartment 206 will be released through the aperture 208. Depending on the fluid within the internal compartment 206, either gas or liquid, and the size and configuration of the aperture 208, the fluid may be released in a squeaking nature or a squirting nature. It is also contemplated the fluid may simply pass through the aperture 208. Upon the termination of the compressive force on the doll 102, the elastic nature of the doll 102 will cause it to return to its initial shape 302. As the doll 102 returns to its initial shape 302, the volume of the internal compartment 206 will increase. As the internal compartment 206 increases, it will create a suction effect through the aperture 208 and the fluid, whether liquid or gas, in the external environment will be sucked into the internal compartment 206.

It is contemplated that the doll 102 may simulate urination through compression of the body. In one embodiment a child may compress the body of the doll 102 to release the liquid within the internal compartment 206. The child may then place the doll 102, in the compressed position, into a liquid such as water. As the compressive force is released, the liquid will be forced into the internal compartment 206 due to the suction effect. The child may lift the doll 102 from the liquid and compress the doll 102, decreasing the volume of the internal compartment 206, and thus forcing the liquid out through aperture 208. In an embodiment in which the aperture 208 is located at the bottom of the doll 102, the liquid released through the aperture will resemble urination. When a child positions the doll 102 roughly centered over the model toilet 104 while compressing the doll 102, the potty training system 100 will resemble urination into a toilet. It is contemplated that this repeated process will reinforce the association of urination with a toilet. The system provides a fun way to introduce potty training to a child and allows the child to actively participate in the process, creating a positive association with potty training This positive association may help to alleviate the intimidation a child may feel with respect to an actual toilet and aid in the potty training process.

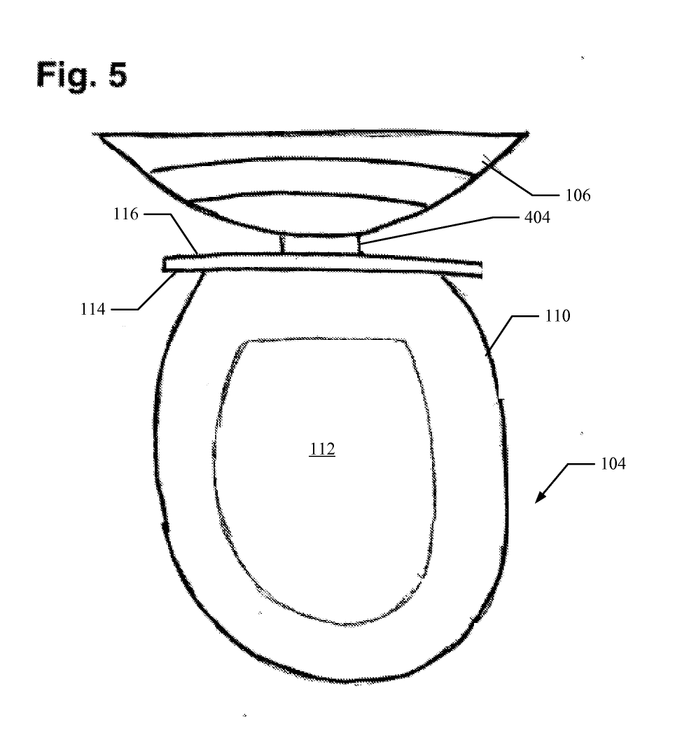

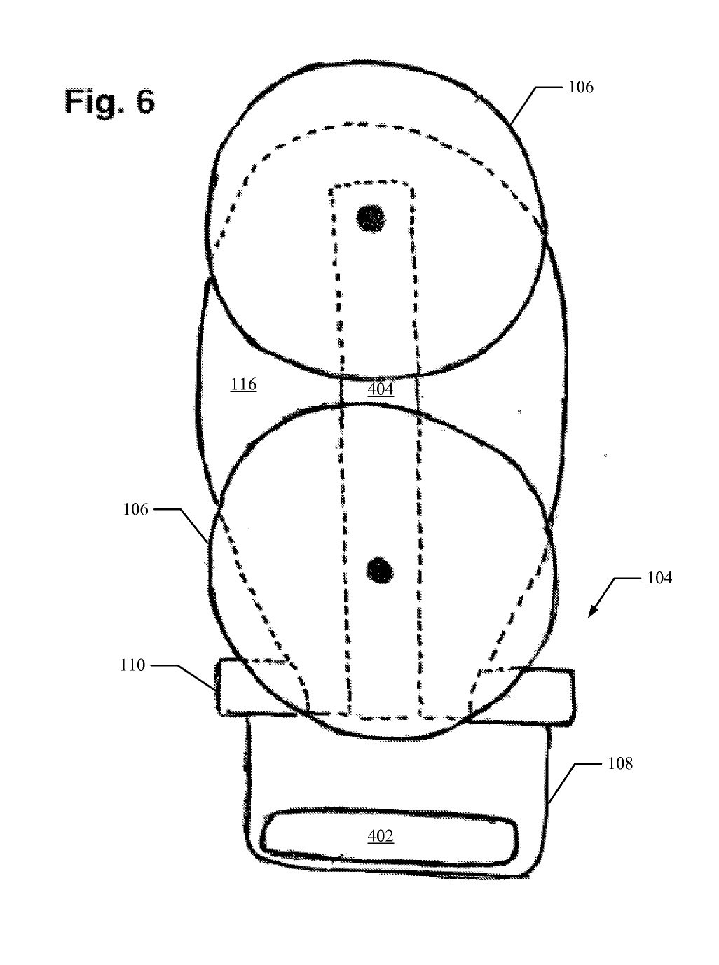

In FIGS. 4, 5 and 6, embodiments of the model toilet 104 are illustrated in more detail. As shown in a cross-section in FIG. 4, in one embodiment, the model toilet 104 may include several components of a functioning toilet such as a toilet bowl 108 with an interior 112 for collecting fluid, a toilet seat 110, and a toilet lid 114 with an exposed backside 116. Additionally, the model toilet 104 may include suction cups 106 and a drain 402. However, in other embodiments the model toilet 104 may include additional or fewer components. It is also understood that the components may differ in size relative to one another and may differ in proportionality compared to those of a functioning toilet.

It is contemplated that the components of the model toilet 104 may be arranged generally as they would on a functioning toilet. However, in other embodiments, the components of the model toilet may be arranged in a different manner. For example, in one embodiment the toilet seat 110 may be arranged such that it sits atop the toilet bowl 108. The toilet bowl 108 may be generally hemispherical or bowl shaped; however, the toilet bowl 108 may alternatively take any shape capable of collecting fluid or allowing fluid to pass through it. The toilet lid 114 may be disproportionally large and may be arranged such that it is permanently in the open position adjacent and affixed to both the toilet seat 110 and the toilet bowl 108. However, in other embodiments, the toilet lid 114 may be orientated in a different manner and may be movable, such that it can be opened or closed.

In embodiments, the model toilet 104 includes a drain 402, which can be implemented as a simple aperture on the lower backside of the toilet bowl 108 providing a pathway between the exterior environment and the interior of the toilet bowl 112. It is understood, however, that the drain 402 may be located anywhere on the toilet bowl 108. However, the drain 402 may allow the model toilet 104 to be used repeatedly in the bathtub without the parent or child having to turn the model toilet 104 over and dump the water out. This allows the model toilet 104 to remain attached to the bathtub surface throughout its use.

In one embodiment, the model toilet 104 may have two suction cups 106 affixed and arranged in series to the backside 116 of the toilet lid 114 along the attachment member 404. The suction cups 106 can be a circular shape and of a diameter capable of creating suction force strong enough to support the model toilet 104. However, it is understood that the suction cups 106 may take any shape and size capable of creating the suction effect. It is also understood that more or fewer than two suction cups 106 may be placed and arranged anywhere on the model toilet 104. In other embodiments, a method other than suction cups 106 may be used for support. For example, a simple hook or strip of Velcro can be used to secure the model toilet 104.

It is contemplated that the suction cups 106 may be used to temporarily affix the model toilet 104 to a surface. In one embodiment, the model toilet 104 may be temporarily affixed to a vertical wall adjacent to a bathtub or shower, or to the bathtub or shower itself. This may be accomplished by simply pressing the suction cups 106 of the model toilet 104 against the wall. With the model toilet 104 temporarily affixed to the wall, the child will have the freedom to use both hands to compress the doll 102. Using both hands may be advantageous considering children lack strength and motor abilities. Additionally, the use of both hands may allow the child to better maneuver the doll 102 from the water to the model toilet 104. In other embodiments, the model toilet 104 may be temporarily affixed via suction cups 106 to a surface, for example a mirror or wall near a sink. Alternatively, the potty training system 100 may be used without affixing the model toilet 102 to any surface. In another embodiment, the model toilet 104 can include a hook or loop or molded fitting, such that the model toilet 104 can be attached to a faucet, handle, spout or other convenient fixture to hold the model toilet 104 generally in place.

In other embodiments, the model toilet 104 can be constructed to float. For example, the model toilet can be formed from a buoyant material and/or shaped to balance and float in liquid. In another embodiment, the model toilet 104 can be attached to a raft that allows the model toilet 104 to float in a bathtub or other bodies of water. In a further embodiment, the model toilet 104 can be attached to a floating ring. For example, a ring of Styrofoam or other buoyant material can be shaped like a life preserver, or other playful shape, and the model toilet 104 can be attached to this material such that the model toilet 104 floats in the bathtub or body of water.

In one embodiment, the doll 102 is constructed of rubber or vinyl. However, any elastic or deformable material capable of returning to its original shape after being deformed may be used. It is also contemplated that the aperture 208 of the doll 102 may be formed during a molding process; however, it is understood that the aperture 208 may be created by puncturing or cutting the doll 102 after molding is completed.

In one embodiment the model toilet 104 may be made of plastic. However, it is understood that in other embodiments the model toilet 104 may be made from any suitable materials including, but not limited to, rubber, porcelain or wood. It is contemplated that the model toilet 104 may be entirely one piece. However, in other embodiments the model toilet 104 may be comprised of several independent components that are later affixed to one another. Additionally, some components may be combined into one component such as the toilet seat 110 and toilet bowl 108.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A device for use in potty-training of a child comprising:
a doll having an internal compartment and at least one aperture that permits fluid intake and/or release from the internal compartment; and
a model toilet having at least a bowl and a support mechanism configured to support the model toilet during use in a bath environment.

2. The device of claim 1, wherein the support mechanism includes at least one suction cup connected to a back of the model toilet for affixing the model toilet to a surface.

3. The device of claim 1, wherein the support mechanism is connected to a back of the model toilet and configured to suspend the model toilet.

4. The device of claim 1, wherein the support mechanism includes buoyant material configured to float the model toilet in liquid.

5. The device of claim 1, the model toilet further comprising a drain configured to allow liquid to empty from the bowl of the model toilet.

6. The device of claim 5, wherein the drain comprises a drain aperture in the bowl.

7. The device of claim 1, wherein the doll is sized and shaped so as to be easily grasped by the child.

8. The device of claim 1, wherein the doll is formed from an elastic material such that when the doll is compressed by the child, fluid is released from the internal compartment.

9. The device of claim 1, the model toilet further comprising scaled elements of a toilet, including a model toilet seat and a model lid.

10. A device for use during potty-training of a child comprising:
an animal-shaped, compressible doll having an internal chamber and at least one aperture that permits fluid intake and release from the internal chamber; and
a model toilet having at least a bowl and a drain configured to empty fluid from the bowl.

11. The device of claim 10, wherein the model toilet is formed at least in part of buoyant material such that the model toilet floats in a liquid.

12. The device of claim 10, further comprising a float configured to connect to the model toilet and support the model toilet in a liquid.

13. The device of claim 10, the model toilet further comprising a support attachment configured to support the model toilet during use.

14. The device of claim 13, wherein the support attachment includes at least one suction cup.

15. The device of claim 10, wherein the aperture is a slit, such that upon compression of the doll, the slit opens allowing liquid to flow in or out of the doll and upon release the slit closes, substantially holding the fluid within the doll.

16. The device of claim 10, wherein the doll is proportionate to the model toilet so as to encourage the child to associate the doll with the toilet.

17. A method for potty-training a child, comprising:
providing a model toilet and a doll having an internal compartment;
affixing the model toilet to a surface of a bath area to support the model toilet during use;
compressing the doll so as to decrease the volume of the internal compartment;
submerging the doll in a liquid and releasing compression to allow the internal compartment to expand and intake the liquid;
removing the doll from the liquid and positioning the doll above the model toilet; and
compressing the doll such that the liquid retained in the internal compartment is released from the internal compartment and into the model toilet.

18. The method of claim 17, wherein affixing the model toilet to a surface of a bath area includes pressing a suction cup connected to the model toilet to the surface of the bath area to support the model toilet.

19. The method of claim 17, wherein affixing the model toilet to a surface of a bath area includes securing a support mechanism attached to the model toilet to a bath fixture in the bath area to support the model toilet.

20. The method of claim 17, wherein the liquid drains from a bowl of the model toilet through a drain aperture located in a base of the bowl.
